(19) United States
(12) Patent Application Publication
(10) Pub. No.: US 2018/0150555 A1
(43) Pub. Date: May 31, 2018

(54) METHOD AND SYSTEM FOR PROVIDING RESOLUTION TO TICKETS IN AN INCIDENT MANAGEMENT SYSTEM

(71) Applicant: Wipro Limited, Bangalore (IN)

(72) Inventors: Selvakuberan KARUPPASAMY, Medavakkam (IN); Amit THAPAK, Pune (IN)

(73) Assignee: Wipro Limited

(21) Appl. No.: 15/412,130

(22) Filed: Jan. 23, 2017

(30) Foreign Application Priority Data
Nov. 28, 2016 (IN) 201641040622

(51) Int. Cl. G06F 17/30

(52) U.S. Cl. CPC G06F 17/30734; G06F 17/30707

(57) ABSTRACT

A technique is provided for providing resolution to tickets in an incident management system. The technique includes dynamically creating, by an analytics module, a taxonomy based on at least a database comprising one or more historical tickets, a description of incidents corresponding to each of the one or more historical tickets, and a corresponding resolution of each of the incidents. The technique further includes receiving, by an input module, one or more current tickets corresponding to an incident encountered by a user. The technique further includes, determining, by a pre-processing module, incident data corresponding to the received one or more current tickets based on pre-processing each of the one or more current tickets. Furthermore, a learning module determines one or more resolution steps corresponding to the received one or more current tickets based on at least the dynamically created taxonomy and the determined incident data.

### TECHNICAL FIELD

This disclosure relates generally to incident management system, and more particularly to method and system for providing resolution to tickets in an incident management system.

### BACKGROUND

Advancements in the field of Information Technology (IT) have enabled digitization of various processes and activities in various industries and enterprises. In light of such digitization, it has become imperative to have an incident management system for providing resolution to any fault or a query of a user in a timely fashion for smooth operation and continuity of businesses. The incident management system may utilize incident tickets that may include a description of the fault or the query associated with the user.

In current implementations, the incident management system takes incident tickets comprising user queries as input, categorizes the tickets into various classes, and routes the tickets to a concerned department for resolution based on the classification. Typically, the departments may comprise separate teams, such as Level 1 or Level 2 service teams, for coordinating with end users and to resolve the incident tickets. Once the resolution is done, the incident ticket is closed. Furthermore, in current techniques, upon submitting the ticket, the system may pick the keywords or error symptoms from the ticket description so as to route the ticket to the concerned team. Also, the system may suggest one or more similar of past incident tickets that have been resolved.

In certain scenarios, the current systems may not capture the error symptoms accurately, such as when the same type of error symptoms is encountered across multiple applications. As an example, “browser issue” may be across different browsers such as Internet Explorer, Mozilla, Chrome, Opera, and the like. In such a scenario, because of the unique nature of each browser, the solution to a problem encountered in a browser may also be different.

Additionally, the current system is limited if the information provided by the user is unclear or incomplete. Further, the similar past resolved tickets suggested by the system may be off the mark in certain cases. For example, the suggestions for “Outlook not working” may be ‘Outlook configuration error’ or ‘Outlook memory error’. These recommendations may not provide any correct response for the exact issue the user may be facing. In all such cases, the resolution team has to come back to the user and clarify the problem. Thus, despite much advancement the resolutions provided by the support team are at times delayed and/or not accurate. These limitations, in turn, affect the overall functioning of the organization or the enterprise.

It is therefore desirable to provide a system that can accurately identify the error symptoms relating to an incident encountered by a user. Further, there is also a need for a system that can reduce the time required for resolving an incident ticket.

### SUMMARY

In one embodiment, a method for providing resolution to tickets in an incident management system, is disclosed. In one example, the method includes dynamically creating, by an analytics module, a taxonomy based on at least a database comprising one or more historical tickets, a description of incidents corresponding to each of the one or more historical tickets, and a corresponding resolution of each of the incidents. The method further includes receiving, by an input module, one or more current tickets corresponding to an incident encountered by a user. The method further includes, determining, by a pre-processing module, incident data corresponding to the received one or more current tickets based on pre-processing each of the one or more current tickets. The method further includes determining, by a learning module, one or more resolution steps corresponding to the received one or more current tickets based on at least the dynamically created taxonomy and the determined incident data.

In one embodiment, a system of providing resolution to tickets in an incident management system, is disclosed. In one example, the system includes dynamically creating a taxonomy based on at least a database comprising one or more historical tickets, a description of incidents corresponding to each of the one or more historical tickets, and a corresponding resolution of each of the incidents. The system further includes receiving one or more current tickets corresponding to an incident encountered by a user. The system further includes determining incident data corresponding to the received one or more current tickets based on pre-processing each of the one or more current tickets. The system further includes determining one or more resolution steps corresponding to the received one or more current tickets based on at least the dynamically created taxonomy and the determined incident data.

In one embodiment, a non-transitory computer-readable medium storing computer-executable instructions providing resolution to tickets in an incident management system, is disclosed. In one example, the stored instructions, when executed by a processor, cause the processor to perform operations that include dynamically creating a taxonomy based on at least a database comprising one or more historical tickets, a description of incidents corresponding to each of the one or more historical tickets, and a corresponding resolution of each of the incidents. The operations further include receiving one or more current tickets corresponding to an incident encountered by a user. The operations further include determining incident data corresponding to the received one or more current tickets based on pre-processing each of the one or more current tickets. The operations further include determining one or more resolution steps corresponding to the received one or more current tickets based on at least the dynamically created taxonomy and the determined incident data

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for providing resolution to tickets in an incident management system, in accordance with some embodiments of the present disclosure.

FIG. 2 is a functional block diagram of incident ticket prediction engine, in accordance with some embodiments of the present disclosure.

FIG. 3 is a flow diagram of an exemplary process overview for providing resolution to tickets in an incident management system, in accordance with some embodiments of the present disclosure.

FIG. 4 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

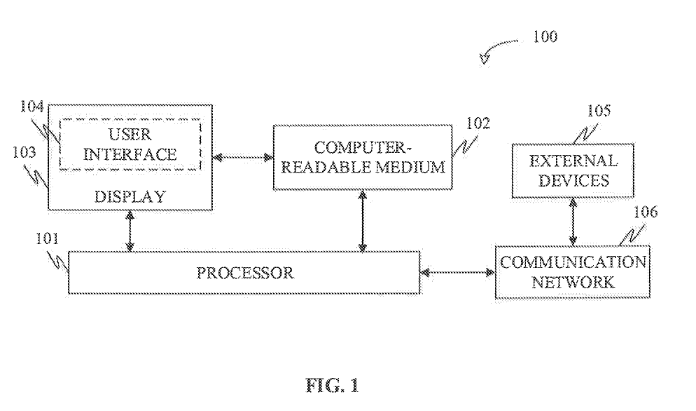

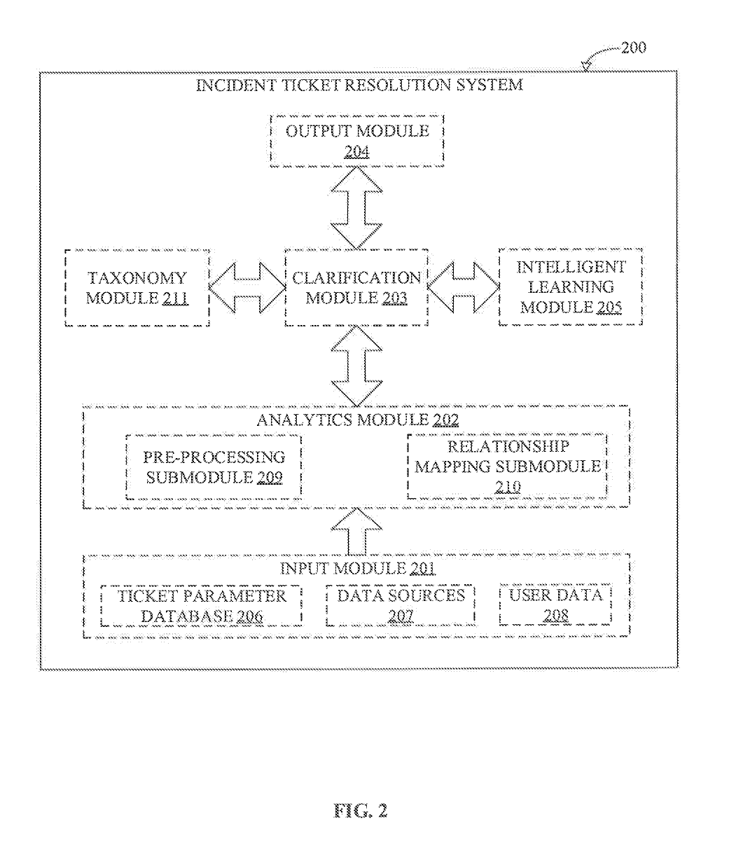

Referring now to FIG. 1, an exemplary system 100 for providing resolution to tickets in an incident management system, is illustrated in accordance with some embodiments of the present disclosure. In particular, the system 100 implements an incident management system to predict most relevant resolutions for tickets corresponding to incident encountered by a user. As will be described in greater detail in conjunction with FIG. 2, the incident management system dynamically creates a taxonomy, receives one or more current tickets, determines incident data corresponding to the received one or more current tickets, and determines one or more resolution steps corresponding to the received one or more current tickets based on at least the dynamically created taxonomy and the determined incident data.

The system 100 comprises one or more processors 101, a computer-readable medium (e.g., a memory) 102, and a display 103. The computer-readable storage medium 102 stores instructions that, when executed by the one or more processors 101 to provide resolution or more processors 101, cause the one to providing resolution to tickets in an incident management system, in accordance with aspects of the present disclosure. The computer-readable storage medium 102 may also store various data (e.g., historical tickets, keywords, Ngrams, categories of the historical tickets, clarifications provided by the user, resolutions corresponding to the historical tickets, relationship mapping between the historical tickets and the resolution provided corresponding to the historical tickets, etc.) that may be captured, processed, and/or required by the system 100. The system 100 interacts with a user via a user interface 104 accessible via the display 103. The system 100 may also interact with one or more external devices 105 over a communication network 106 for sending or receiving various data. The external devices 105 may include, but are not limited to, a remote server, a digital device, or another computing system.

Referring now to FIG. 2, a functional block diagram of the incident ticket resolution system 200 implemented by the system 100 of FIG. 1 is illustrated, in accordance with some embodiments of the present disclosure. The incident ticket resolution system 200 may include various modules that perform various functions for providing relevant resolution to incident tickets. In some embodiments, the incident ticket resolution system 200 comprises an input module 201, an analytics module 202, a clarification module 203, output module 204, intelligent learning module 205, ticket parameter database 206, data source module 207, user data module 208, pre-processing submodule 209, relationship mapping submodule 210, and taxonomy module 211.

The input module 201 receives input from one or more sources that enables the incident ticket resolution system 200 to provide resolution to one or more current tickets reported by the user. The one or more current tickets correspond to one or more incidents encountered by the user. In an embodiment, the input to the input module 201 may include data received from one or more of the ticket parameter database 206, the data sources 207, and directly from the user in the form of user data 208. The ticket parameter database 206 includes ticket dumps related to one or more historical tickets and resolutions corresponding to the one or more historical tickets. In some embodiments, the ticket dumps stored in the ticket parameter database 206 may be in the form of comma-separated values (CSV) file or one or more Microsoft excel files. The stored ticket dumps may include a number of fields or parameters such as an identification of a ticket that may be a ticket ID or a ticket number. In some embodiment, the ticket dumps may further include summary of a ticket, severity of a ticket, time of reporting a ticket, time of resolution of a ticket, a category of resolution of a ticket. Furthermore, the ticket dumps may further include a domain of a historical ticket, a title of a historical ticket, a ticket or a problem description, a description of a resolution provided corresponding to a historical ticket, and the like.

In an embodiment, the data sources 207 may correspond to one or more personnel from a Level 1 (L1) service team and/or a Level 2 (L2) service team. In some embodiments, the L1 and/or L2 personnel may be assigned a role of manually providing resolving one or more tickets assigned to them. The L1 and/or L2 personnel are typically within the functions of the organization but in some implementations they may correspond to service providers that are external to the incident management system. The input from data sources 207 may include various other parameters such as resolution date and time, etc.

In an embodiment, the user data 208 may correspond to one or more inputs provided by the user in the form of one or more current tickets. Such one or more current tickets may include a user query containing that includes a summary of the problem encountered by the user corresponding to an incident. Such user query may further be provided in the description of the ticket.

The analytics module 202 may typically include a pre-processing submodule 209 and relationship mapping submodule 210. The pre-processing submodule 209 may be configured to extract the structured description from the ticket dumps corresponding to the one or more historical tickets stored in the ticket parameter database 206. Such an extraction of the structured description from the ticket dumps may be required to facilitate dynamic creation of a taxonomy. The pre-processing submodule 209 may be further configured to extract structured description from the current tickets reported by the user. In an embodiment, the structured description extracted from the one or more current tickets may correspond to incident data. In an embodiment, the incident data corresponds to at least a category of the incident, a severity of the incident, a domain of an incident encountered by the user.

In some embodiments, the pre-processing of the ticket dumps may include, but is not limited to, removing URLs, removing numbers, removing generic stop words, removing custom stop words, removing e-mails, removing special characters, removing date and time values, and the like. Such an operation is performed the aforementioned information may have little or no contribution to content, context, and meaning of the ticket. Further, in some other embodiments, the pre-processing may involve extracting the specific information needed from a form or an e-mail based pattern, using regex. In an embodiment, the pre-processing of the one or more current tickets may be performed based on techniques that include, but are not limited to, a Natural Language Processing (NLP) algorithm or a text analyzer.

The relationship mapping submodule 210 is configured to analyse the stored ticket dumps and identify relationship between incident or error symptoms associated with the extracted structured description, and the resolutions corresponding to the reported incident associated with the ticket dumps (constituting the one or more historical tickets).

Additionally, in certain scenarios, when the incident data is not sufficient for identifying the aforementioned relationship, the clarification module 203 may be configured to request for clarifications from the user. Such clarifications may correspond to additional data associated with the one or more current tickets reported by the user. In an example, when the one or more current tickets correspond to an issue relating to malfunctioning browser, the clarification required by the clarification module 203 may be the details of the browser in which the incident has been encountered by the user.

In an embodiment, the ticket parameter database 206 may be initialized with the one or more ticket dumps corresponding to the one or more historical tickets. Further, based on the aforementioned identification of the relationship and the initialization of the database, the taxonomy module 211 may be configured to dynamically create a taxonomy. In an embodiment, the taxonomy may be based on a classification of the one or more historical tickets based on at least a description of incidents corresponding to each of the one or more historical tickets, and a corresponding resolution of each of the incidents.

In an embodiment, the intelligent learning module 205 may be configured to determine one or more resolution steps corresponding to the received one or more current tickets. In an embodiment, based on the determined incident data, the intelligent learning module 211 may be configured to refer to the dynamically created taxonomy. Such an operation may include determination of the one or more relevant resolution for the incident encountered by the user. For example, the current ticket is pre-processed to get the actual error symptoms associated with the incident. The error symptoms are mapped to the created taxonomy and identified the slots relevant to the incident are identified in the taxonomy. The slots differentiate the exact error symptom and facilitate providing resolution. The intelligent learning module 211 may be further include a learning agent based on which machine learning techniques may be applied on by the module for incremental learning. Thus, upon receiving the one or more current tickets, the intelligent learning module 211, in conjunction with the analytics module 202 may be configured to provide a resolution the one or more current tickets reported by the user.

In an embodiment, the output module 204 may be configured to display the determined one or more steps on an associated display. In other embodiments, the intelligent learning module 211 may be configured to automatically execute one or more steps for resolving the incident encountered by the user, based on the determined resolution steps.

It should be noted that the incident ticket resolution system 200 may be implemented in programmable hardware devices such as programmable gate arrays, programmable array logic, programmable logic devices, and so forth. Alternatively, the incident ticket resolution system 200 may be implemented in software for execution by various types of processors. An identified engine of executable code may, for instance, comprise one or more physical or logical blocks of computer instructions which may, for instance, be organized as an object, procedure, function, module, or other construct. Nevertheless, the executables of an identified engine need not be physically located together, but may comprise disparate instructions stored in different locations which, when joined logically together, comprise the engine and achieve the stated purpose of the engine. Indeed, an engine of executable code could be a single instruction, or many instructions, and may even be distributed over several different code segments, among different applications, and across several memory devices.

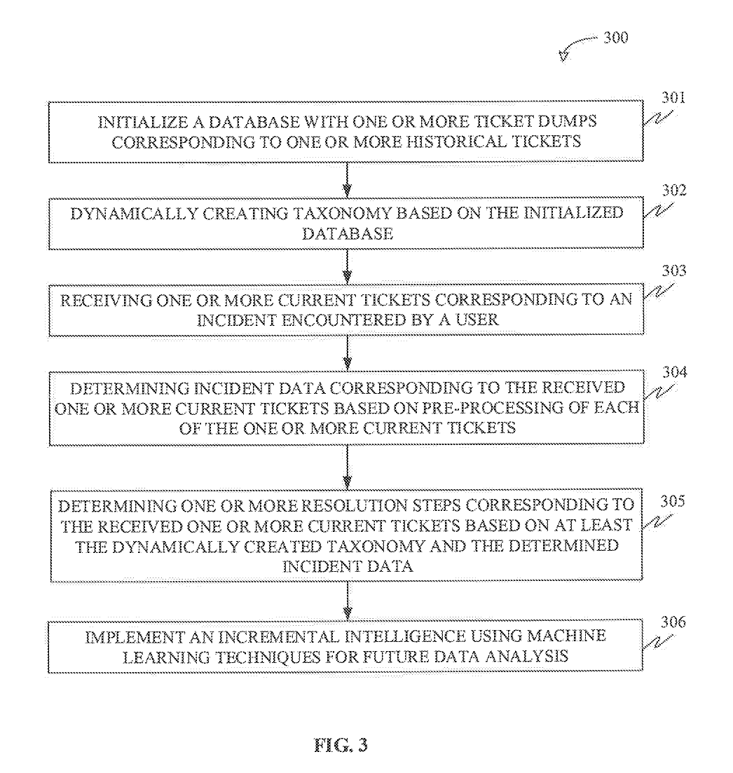

Referring now to FIG. 3, an overview of an exemplary process 300 for providing resolution to tickets in an incident management system, is depicted via a flowchart in accordance with some embodiments of the present disclosure. Elements of FIG. 3 have been explained in conjunction with the elements of FIGS. 1 and 2. The process 300, at step 301, involves the steps of initializing the ticket parameter database 206 with one or more ticket dumps that correspond to one or more historical tickets. At step 302, the process includes dynamically creating a taxonomy based on the initialized ticket parameter database 206. At step 303, the process includes, receiving one or more current tickets from a user, corresponding to an incident. At step 304, the process includes determining incident data from the one or more current tickets based on pre-processing. At step 305, the process includes determining one or more resolutions for the incident based on the dynamically created taxonomy. At step 306, the process includes implementing incremental learning based on machine learning algorithms. Each of the aforementioned steps will be described in greater detail herein below.

At step 301, the system is initialized with the ticket repository or ticket dumps. In some embodiments, the ticket dump may include tickets from past two, three, or six months along with the corresponding resolutions. In an embodiment, ticket dumps comprise at least an identification of a ticket, summary of a ticket, severity of a ticket, time of reporting a ticket, time of resolution of a ticket, a category of resolution of a ticket.

At step 302, pre-processing submodule 209 may be configured to extract the structured description from the ticket dumps corresponding to the one or more historical tickets stored in the ticket parameter database 206. Such an extraction of the structured description from the ticket dumps may be required to facilitate dynamic creation of a taxonomy. Based on the extracted structured description from the ticket dumps, the relationship mapping submodule 210 may analyse the stored ticket dumps and identify relationship between incident or error symptoms associated with the extracted structured description, and the resolutions corresponding to the reported incident associated with the ticket dumps (constituting the one or more historical tickets).

In an embodiment, the analysis may include, analyzing the noun phrases and extracting the keywords out from the ticket description in the ticket dumps. The analysis may further include performing the aforementioned analysis on the description of the resolutions corresponding to the tickets that form a part of the ticket dumps. Further, based on the aforementioned analysis performed, a clustering may be performed corresponding to a class of tickets (based on ticket description) and the corresponding resolutions. Furthermore, the relationship mapping submodule 210 may create a hierarchy or a sibling based relationship between a class of tickets and the corresponding classes of the resolutions provided for the tickets. Based on the aforementioned classification, a taxonomy may be dynamically created by the taxonomy module 211. Such a taxonomy may be indicative of errors or issues faced by a user, corresponding symptoms associated with such errors and issues, along with the prospective resolutions corresponding to the errors or issues. In an embodiment, the dynamically created taxonomy may be stored in a persistent memory associated with the incident ticket resolution system 200. Furthermore, in an embodiment, the taxonomy may be updated periodically based on the tickets reported into the incident ticket resolution system 200.

At step 303, one or more current tickets may be received from a user by the input module 201. The user data 208 may correspond to one or more inputs provided by the user in the form of one or more current tickets. Such one or more current tickets may include a user query containing that includes a summary of the problem encountered by the user corresponding to an incident.

At step 304, the pre-processing submodule 209 may pre-process the received one or more current tickets to determine incident data. In an embodiment, the incident data may include, but is not limited to, a category of the incident, a severity of the incident, a domain of an incident encountered by the user.

In an embodiment, pre-processing submodule 209 may include built-in natural language processing (NLP) and text analyzer components. These components analyze the one or more current tickets by removing the junks, spam, and stop words and by identifying the co-reference relationship between the sentences. The output from these components may be the keywords and named entities that may be subsequently clustered into various categories.

The NLP component receives the ticket dumps of the one or more current tickets as input. The NLP component further captures the user utterances in the ticket logs of the one or more current tickets and performs processing on it. The processing of the text include identification of the individual sentences, tokenization of the sentence in the text, identification of the named entities like name of the places, organization, currency, time, date, and so forth. Also, NLP component may be employed to identify the noun and verb phrases in the sentence. Thus, the NLP component determines the relationship between the sentences in the service ticket and identifies the nouns and pronouns that describe the problem. The text analyzer component removes the unwanted junks from the user query. The text analyzer helps in the identification of keywords from the user query. The NLP component and the text analyzer component combine to form the necessary named entities and keywords that enable the identification of the clusters for the particular query or the incident ticket.

Thus, in some embodiments, by passing the user utterance to NLP and text analyzer component, the output will be the keywords from the user utterances. The output from the pre-processing submodule may then be provided to the relationship mapping submodule 210 to identify the groups the user utterance may be mapped to.

At step 305, the taxonomy module 211 may determine one or more resolution steps corresponding to the received one or more current tickets. Such a determination may be based on the dynamically created taxonomy in step 302. In an embodiment, when one or more current tickets are received by the system, the query or the text may be parsed in accordance with the pre-processing steps explained in the step 304. Such a pre-processing may assist the system to identify a category of an incident encountered by the user and/or one or more error symptom associated with the incident. Based on the identification, the taxonomy module 211 may refer to the dynamically created taxonomy to understand the error symptoms and map the correct resolution. As an example, in a scenario when the current ticket includes a description, such as “Outlook crashed”, the system may relate the aforesaid description with the historical tickets where the description included keywords such as “malfunction”, “inoperational”, “down”, and the like. This is because based on the relationship mapping and the classification performed above, the system is able to categorize the historical tickets containing the aforesaid keywords under one taxonomy. When a current ticket is entered into the system and the incident data of that ticket corresponds to the same taxonomy, the system may suggest, to the user, the resolution that correspond to the historical tickets having the same taxonomy as the current ticket.

Based on the aforementioned, in scenarios when multiple resolution are determined corresponding to the incident, then the clarification module 208 may generate one or more question for the user. Such one or more questions correspond to one or more additional inputs that may be required from the user. For example, in an exemplary scenario, the incident encountered by the user may be a browser issue and the corresponding current ticket may include a user query of the form “I am facing browser issue”. However, when the taxonomy is referred, the system may come up with a plurality of resolutions that may correspond to different browsers, such as Internet Explorer, Chrome, Mozilla Firefox, and the like. In such a scenario, the system may not be able to accurately provide a resolution that may address the issue. Therefore, in such scenarios, the clarification module 208 may generate a prompt that may be displayed to the user, via the output module 204. Such a prompt may seek information corresponding to the type of browser in which the incident occurred. For example, the prompt may be of the form “Which browser you are using?” In response to the prompt, when a clarification input is received from the user, via the input module 201, the system may refer to the taxonomy again in order to determine a precise resolution for the current ticket.

At step 306, an incremental intelligence may be implemented using machine learning techniques for future data analysis. The entire system may be monitored by the intelligent agent and the system learns from the user's behavior and with the existing data. From the user query entering the system till the user gets the response output, the intelligent agent captures the data and learns incrementally to aid the actual learning of the system. In an embodiment, the determined resolution may be displayed to the user, via the output module 204. In another embodiment, the system may automatically execute one or more steps for resolving the incident encountered by the user.

As will be appreciated by one skilled in the art, a variety of processes may be employed for predicting relevant resolution for an incident ticket. For example, the exemplary system 100 and the associated incident ticket resolution system 200 may provide relevant resolution for an incident ticket by the processes discussed herein. In particular, as will be appreciated by those of ordinary skill in the art, control logic and/or automated routines for performing the techniques and steps described herein may be implemented by the system 100 and the associated incident ticket resolution system 200, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

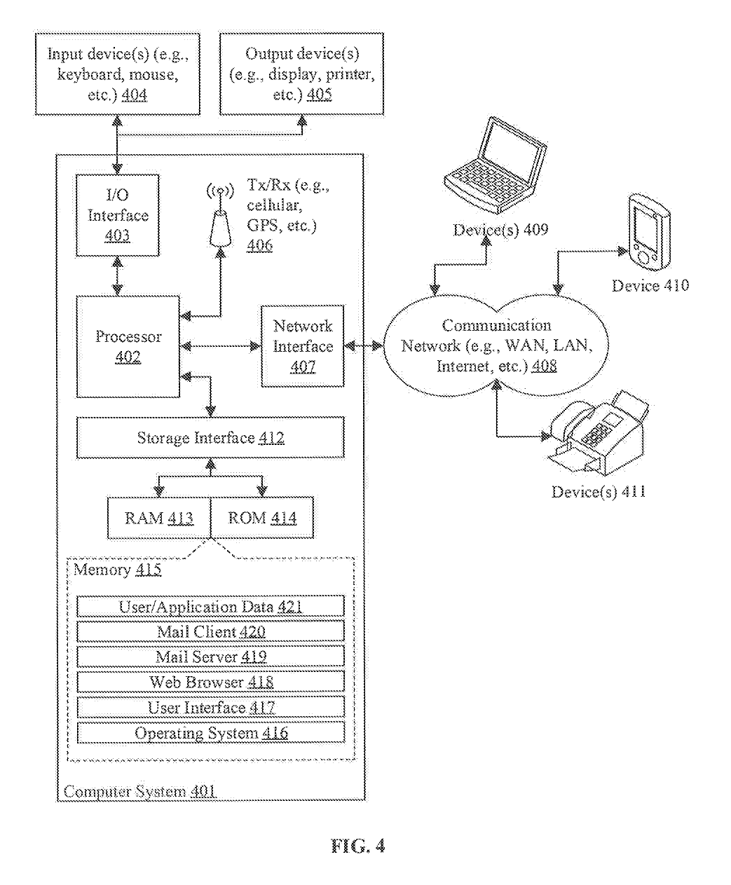

The disclosed methods and systems may be implemented on a conventional or a general-purpose computer system, such as a personal computer (PC) or server computer. Referring now to FIG. 4, a block diagram of an exemplary computer system 401 for implementing embodiments consistent with the present disclosure is illustrated. Variations of computer system 401 may be used for implementing system 100 and incident ticket resolution system 200 for predicting relevant resolution for an incident ticket. Computer system 401 may comprise a central processing unit (“CPU” or “processor”) 402. Processor 402 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 418-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. (e.g., past ticket repository, keywords, Ngrams, clusters or categories, relationship mapping, user queries, resolutions, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above result in automated, efficient, and speedy resolution of incident tickets. The techniques provide for a prediction model derived from past tickets repository that can provide the most appropriate or relevant resolution for an incident ticket in real-time, thereby reducing the manual effort and the time delay in providing accurate resolution. Further, the techniques described in the various embodiments discussed above increase the productivity of the user as well as the resolution team handling those tickets. The user can have quick resolution to his query while the resolution team may focus on new issues for which there are no mapped resolutions.

Additionally, as will be appreciated by those skilled in the art, the prediction model learns new errors and tries to map the resolutions for the new errors. The resolution model understands the relationship between the error and the cluster/resolution model may analyze a number of times same error is being faced by the users in a given period of time and other such information. Such information may be very useful in not only improving the prediction model but also the overall IT infrastructure.

The specification has described system and method for predicting relevant resolution for an incident ticket. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such altematives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of providing resolution to tickets in an incident management system, the method comprising:
dynamically creating, by an analytics module, a taxonomy based on at least a database comprising one or more historical tickets, a description of incidents corresponding to each of the one or more historical tickets, and a corresponding resolution of each of the incidents;
receiving, by an input module, one or more current tickets corresponding to an incident encountered by a user;
determining, by a pre-processing module, incident data corresponding to the received one or more current tickets based on pre-processing each of the one or more current tickets;
determining, by a learning module, one or more resolution steps corresponding to the received one or more current tickets based on at least the dynamically created taxonomy and the determined incident data.

2. The method of claim 2, wherein the dynamic creation of the taxonomy comprises:
initializing a database with the one or more ticket dumps corresponding to one or more historical tickets; and
classifying the one or more historical tickets stored in the database, based on at least the incident description and a corresponding resolution of the incident.

3. The method of claim 2, wherein the one or more ticket dumps comprise at least: an identification of a ticket, summary of a ticket, severity of a ticket, time of reporting a ticket, time of resolution of a ticket, a category of resolution of a ticket.

4. The method of claim 1, wherein the incident data corresponds to at least: a category of the incident, a severity of the incident, a domain of an incident.

5. The method of claim 1, wherein the determination of the incident data comprises iteratively determining, via a clarification module, one or more additional inputs corresponding to the one or more current tickets, from the user.

6. The method of claim 1, wherein the pre-processing of the one or more current tickets is performed based on at least a Natural Language Processing (NLP) algorithm and a text analyzer.

7. The method of claim 1, further comprising performing incremental learning, by the learning module, based on the determined one or more resolution steps corresponding to the one or more current tickets.

8. The method of claim 1, wherein the one or more resolution steps are executed automatically by an output module, for resolving the incident encountered by the user.

9. A system for providing resolution to tickets in an incident management system, the system comprising:
a processor; and
a memory communicatively coupled to the processor, wherein the memory stores the processor-executable instructions, which, on execution, causes the processor to:
dynamically create a taxonomy based on at least a database comprising one or more historical tickets, a description of incidents corresponding to each of the one or more historical tickets, and a corresponding resolution of each of the incidents;
receive one or more current tickets corresponding to an incident encountered by a user;
determine incident data corresponding to the received one or more current tickets based on pre-processing each of the one or more current tickets;
determine one or more resolution steps corresponding to the received one or more current tickets based on at least the dynamically created taxonomy and the determined incident data

10. The system of claim 9, wherein the dynamic creation of the taxonomy comprises:
initializing a database with the one or more ticket dumps corresponding to one or more historical tickets; and
classifying the one or more historical tickets stored in the database, based on at least the incident description and a corresponding resolution of the incident.

11. The system of claim 10, wherein the one or more ticket dumps comprise at least: an identification of a ticket, summary of a ticket, severity of a ticket, time of reporting a ticket, time of resolution of a ticket, a category of resolution of a ticket.

12. The system of claim 9, wherein the incident data corresponds to at least: a category of the incident, a severity of the incident, a domain of an incident.

13. The system of claim 9, wherein the determination of the incident data comprises iteratively determining, via a clarification module, one or more additional inputs corresponding to the one or more current tickets, from the user.

14. The system of claim 9, wherein the pre-processing of the one or more current tickets is performed based on at least a Natural Language Processing (NLP) algorithm and a text analyzer.

15. The system of claim 9, further comprising performing incremental learning, by the learning module, based on the determined one or more resolution steps corresponding to the one or more current tickets.

16. The system of claim 9, wherein the one or more resolution steps are executed automatically by an output module, for resolving the incident encountered by the user.

17. A non-transitory computer-readable medium storing instructions for providing resolution to tickets in an incident management system, wherein upon execution of the instructions by one or more processors, the processors perform operations comprising:
dynamically creating a taxonomy based on at least a database comprising one or more historical tickets, a description of incidents corresponding to each of the one or more historical tickets, and a corresponding resolution of each of the incidents;
receiving one or more current tickets corresponding to an incident encountered by a user;
determining incident data corresponding to the received one or more current tickets based on pre-processing each of the one or more current tickets;
determining one or more resolution steps corresponding to the received one or more current tickets based on at least the dynamically created taxonomy and the determined incident data.
